(19) United States
(12) Patent Application Publication
(10) Pub. No.: US 2022/0093286 A1
(43) Pub. Date: Mar. 24, 2022

(54) ALUMINUM CARBON NANOTUBE (AL-CNT) WIRES IN TRANSMISSION OR DISTRIBUTION LINE CABLES

(71) Applicant: YAZAKI CORPORATION, Tokyo (JP)

(72) Inventors: Stefan Maat, Camarillo, CA (US); Markus Boehm, Camarillo, CA (US)

(21) Appl. No.: 17/457,600

(22) Filed: Dec. 3, 2021

Related U.S. Application Data
(63) Continuation of application No. PCT/US2020/036176, filed on Jun. 4, 2020.
(60) Provisional application No. 62/857,555, filed on Jun. 5, 2019.

(51) Int. Cl. H01B 1/02; B21C 23/08; H01B 5/08; H01B 13/00; C22C 21/00

(52) U.S. Cl. CPC H01B 1/023; B21C 23/08; C22C 21/00; H01B 13/0036; H01B 5/08

(57) ABSTRACT

A transmission line cable with conductors includes a metal-matrix composite (MMC) conductor of carbon nanotubes (CNT) dispersed in aluminum (Al) metal matrix. The concentration of CNT is uniform throughout an entirety of the MMC conductor.

### CROSS-REFERENCE TO RELATED APPLICATIONS

This application is a continuation of PCT/US2020/036176, entitled “ALUMINUM CARBON NANOTUBE (AL-CNT) WIRES IN TRANSMISSION OR DISTRIBUTION LINE CABLES,” filed Jun. 4, 2020, which claims the benefit of U.S. Provisional Application No. 62/857,555, entitled “ALUMINUM CARBON NANOTUBE (AL-CNT) WIRES IN TRANSMISSION LINE CABLES,” filed Jun. 5, 2019. The contents of the above-identified applications are incorporated herein by reference in their entirety.

### BACKGROUND

An overhead power line is a structure used in electric power transmission and distribution to transmit electrical energy across large distances. It consists of one or more conductors (commonly multiples of three) suspended by towers or poles. Since most of the insulation is provided by air, overhead power lines are generally the lowest-cost method of power distribution for large amounts of electric energy. Overhead aluminum conductors are used as power transmission and distribution lines. All-aluminum conductor (AAC), all-aluminum alloy conductor (AAAC), aluminum conductor steel reinforced (ACSR), aluminum conductor steel supported (ACSS), aluminum conductor fiber reinforced (ACFR), aluminum conductor composite reinforced (ACCR), and aluminum conductor composite core (ACCC) are types of overhead conductors, transmission conductors, and power distribution conductors. Generally, all aluminum conductors are made up of one or more strands of aluminum or aluminum-alloy wire depending on the specific application.

### BRIEF DESCRIPTION OF THE DRAWINGS

One or more embodiments of the present disclosure are illustrated by way of example and not limitation in the figures of the accompanying drawings, in which like references indicate similar elements.

FIG. 1A is a schematic that illustrates a transmission line cable and associated cross section including multiple stranded conductors, for example aluminum, aluminum-alloy, or aluminum carbon nanotubes (Al-CNT) conductors.

FIG. 1B is a schematic that illustrates a transmission line cable and associated cross section including multiple wires forming a stranded core and multiple conductors, for example aluminum, aluminum-alloy, or aluminum carbon nanotubes (Al-CNT) conductors, wound or stranded around the core.

FIG. 2 is a graph that shows strengthening of aluminum and Al-CNT rods with initial diameters by cold drawing to obtain desired diameters.

FIG. 3 is a graph that shows retention of ultimate tensile strength (UTS) after heating Al and Al-0.5 wt % CNT conductors at various temperatures.

FIG. 4 is a flowchart of a process for manufacturing an Al-CNT composite conductor for a transmission line cable.

FIG. 5 is a graph that shows ampacity relative to line temperature for an Akron all-aluminum alloy conductor (AAAC) cable.

FIG. 6 is a graph that shows ampacity relative to line temperature for a Butte AAAC cable.

FIG. 7 is a graph that shows ampacity relative to line temperature for a Turkey aluminum conductor steel reinforced (ACSR) cable.

FIG. 8 is a graph that shows ampacity relative to line temperature for a Drake ACSR cable.

The drawings, some components and/or operations can be separated into different blocks or combined into a single block when discussing some embodiments of the present technology. Moreover, while the technology is amenable to various modifications and alternative forms, specific embodiments have been shown by way of example in the drawings and are described in detail below. The intention, however, is not to limit the technology to the particular embodiments described herein. On the contrary, the technology is intended to cover all modifications, equivalents, and alternatives falling within the scope of the technology as defined by the appended claims.

### DETAILED DESCRIPTION

The embodiments set forth below represent the necessary information to enable those skilled in the art to practice the embodiments and illustrate the best mode of practicing the embodiments. Upon reading the following description in light of the accompanying figures, those skilled in the art will understand the concepts of the disclosure and will recognize applications of these concepts that are not particularly addressed herein. It should be understood that these concepts and applications fall within the scope of the disclosure and the accompanying claims.

The purpose of terminology used herein is only for describing embodiments and is not intended to limit the scope of the disclosure. Where context permits, words using singular or plural form may also include the plural or singular form, respectively.

### Terminology

As used herein, the term “about” refers to ±10% of the recited value. For example, about 10 meters refers to 10 meters±1 meter.

As used herein, terms such as “uniformly” or “evenly” in the context of a distribution can refer to a homogenous distribution. Details are explained in the later section.

As used herein, the term “wire” can refer to a single stand of material which may be a conducting metal or an essentially non-conducting composite material.

As used herein, the term “conductor” can refer to an electrical conductor such as a metal wire. The wires can be referred to as “strands” due to their shape, though strands are not necessarily formed of conductive material.

As used herein, the term “cable” can refer to a plurality of stranded wires, for example a cable comprised of stranded aluminum or aluminum-alloy conductors (such as an AAAC cable) or a cable comprised of stranded steel wires forming a core and aluminum conductors stranded around the core (such as an ACSR or ACSS cable).

As used herein, the terms “work hardening” or “strain hardening” can refer to strengthening a metal or polymer by deformation. An example of work hardening is that which occurs in metalworking processes that intentionally induce deformation to exact a shape change. These processes are known as cold working or cold forming processes. They are characterized by shaping the workpiece at a temperature below its recrystallization temperature (e.g., usually at ambient temperature). Cold forming may be accomplished through techniques such as, but not limited to, squeezing, bending, drawing, rolling, and shearing.

As used herein, “dispersion hardening” can refer to a process in which the strength of a material is improved due to the presence of insoluble hard particles such as carbon nanotubes (CNT) distributed in a matrix such as aluminum.

Aluminum Carbon Nanotube (Al-CNT) Conductors

Aluminum is commonly used in wiring because of its relatively good conductivity, low density, and material cost. The conductivity of aluminum is about 61.2% to 61.8% compared to that of copper (based on the International Annealed Copper Standard, or IACS). The density of aluminum is 2.71 g/cm³ compared to the density of copper, which is about 8.92 g/cm³. While the cost of aluminum and copper metals fluctuate, historically the cost of aluminum is far less than half that of copper. Aluminum wires with the same conductance as copper wires have about a 67% larger cross section but weigh about only half as much due to the lower density. Moreover, aluminum wires with the same conductance cost much less than counterpart copper wires.

A major drawback of pure aluminum wires is that their mechanical strength is limited. For example, the tensile strength of a 1350 aluminum wire is in the range of about 60 to 200 MPa depending on the thermal treatment. For example, dead-soft annealed 1350-0 aluminum wire has a tensile strength in the range of 60 to 95 MPa, and 1350-H19 aluminum wire has a tensile strength in the range of 160 MPa to 200 MPa depending on the wire diameter. For that reason, aluminum alloys such as 6201-T81 are used in wires, which will exhibit a tensile strength of about 315 to 330 MPa depending on the wire diameter; however, at a markedly lower conductivity of about 52.5% IACS. Another drawback of aluminum and aluminum alloys, in comparison to copper, is that they are much less creep-resistant.

The disclosed solution includes a composition for aluminum-based wires that exhibits a conductivity similar to pure aluminum wires (e.g., 1350-0 or 1350-H19 wires) but with the strength of aluminum alloy wires (e.g., 6201-T81 wires), and has improved creep resistance relative to aluminum-based wires. For example, a small addition of carbon nanotubes (CNT) (e.g., less than 2 weight percent (wt %), more preferably <1 wt %) to an aluminum metal matrix provides increased tensile wire strength, higher heat-resistance, and higher creep resistance compared to pure aluminum without CNT, while maintaining a substantially similar conductivity, modulus of elasticity, and coefficient of thermal expansion. While the tensile strength and creep-resistance of Al-CNT increases with increased CNT weight ratio in the composite, the electrical conductivity decreases. As such, a concentration greater than 0.4 wt % CNT, more preferably 0.4 wt % to 0.6 wt % CNT, or even more preferably 0.5 wt % CNT can maintain an electrical conductivity of about 60% IACS. In particular, an aluminum metal-matrix composite (MMC) wire with 0.5 wt % CNT can exhibit a strength greater than 200 MPa and even 300 MPa while satisfying the AT4 specifications of the International Electrotechnical Commission (IEC) 62004 heat resistance standard for overhead transmission lines (as summarized in Table 1), and can exhibit a conductivity close to that of 1350 aluminum (i.e. about 60% IACS).

An Al-CNT wire can attain mechanical strengthening with work and dispersion hardening by successively reducing the cross-section of an extruded Al-CNT rod through a cold working process (such as but not limited to rolling, drawing, or a combination thereof) until a desired diameter for the rod is obtained. During the cold working process to achieve the desired diameter, the grain structure of the rod is refined and CNT disperses more evenly in the wire.

Disclosed embodiments include an application of work and dispersion hardened Al-CNT wires for transmission and distribution line cables with examples using an all-aluminum alloy conductor (AAAC) and aluminum conductor steel reinforced (ACSR) transmission-line cables. Therefore, the Al-CNT composite can overcome drawbacks of conventional aluminum or aluminum-alloy based cables.

For example, replacing Al-alloy conductors (e.g., Al 6201-T81) with Al-CNT conductors of similar tensile strength in all aluminum alloy conductor (AAAC) cables will result in higher ampacity rating due to the higher conductivity and higher heat resistance of the Al-CNT conductors, compared to 6201-T81 Al-alloy conductors typically used in AAAC cables.

In another example, replacing aluminum conductors with Al-CNT conductors in steel reinforced (ACSR) cables will result in a higher ampacity rating due to a similar conductivity and higher heat resistance of Al-CNT conductors compared to Al-1350-H19 conductors that are typically used in ACSR cables. ACSR cables still depend on the strength of the aluminum conductors and are only reinforced by a steel core to support the weight of the cable, particularly for larger cable diameters. The higher tensile strength of the Al-CNT composite compared to aluminum will therefore improve the overall cable strength.

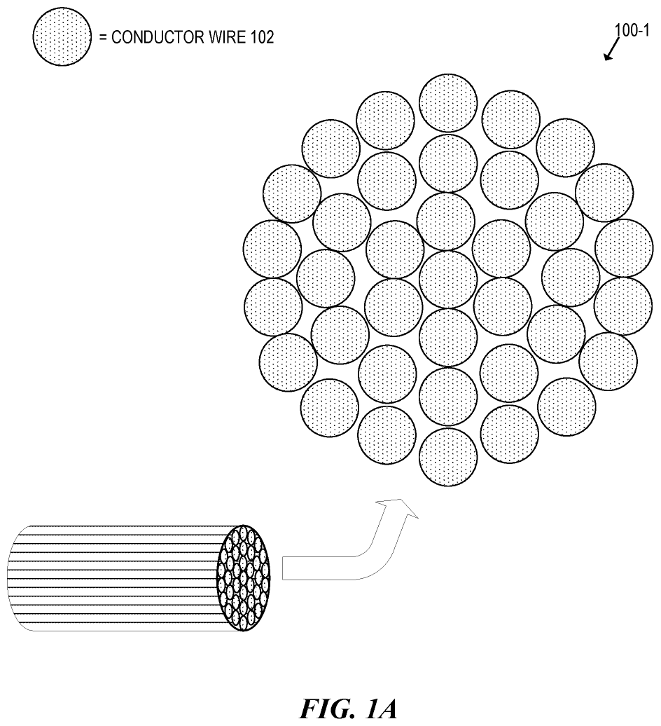

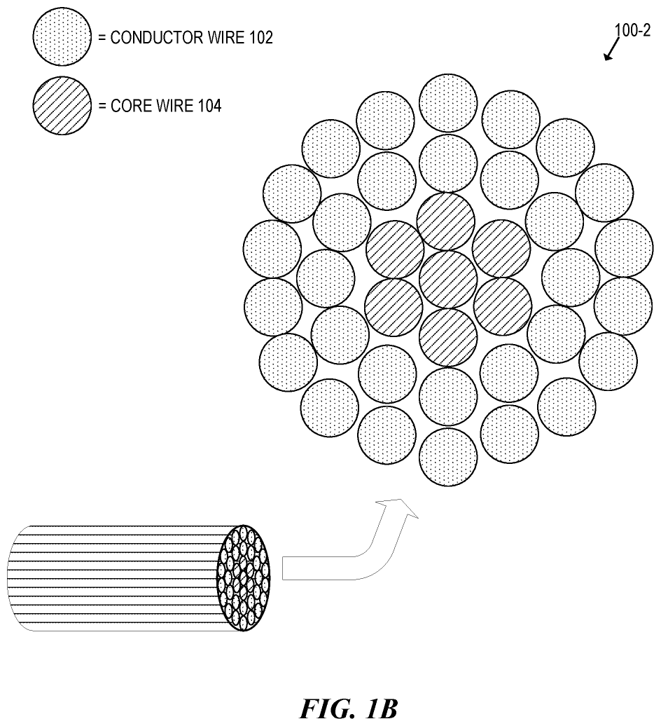

FIG. 1A is a schematic that illustrates a transmission line cable 100-1 (“cable 100-1”) and associated cross section including multiple conductors 102. As shown, the cable 100-1 is formed by stranding conductors 102 together. For example, in an AAC cable, all conductors are comprised of aluminum, while in an AAAC cable, all conductors are comprised of an aluminum-alloy such as 6201-T81. In some embodiments, all conductors are comprised of an Al-CNT composite material, where the CNT is dispersed uniformly through the entirety of each conductor. The number and gauge of the conductors stranded together (typically 7, 19, or 37) may be appropriately modified in accordance with a purpose of use of the cable 100-1. While the cross-sectional shapes of the conductors are shown as round, the cross-sectional shape may also be trapezoidal, for example in an AAAC/TW cable. In some embodiments, an insulating material such as a polymer sleeve (not shown) can cover the outermost surface of the cable.

FIG. 1B is a schematic that illustrates a transmission line cable 100-2 (“cable 100-2”) and associated cross section including multiple core wires 104 and conductors 102. As shown, the cable 100-2 is formed by stranding conductors 102 around a core formed of stranded wires 104 which reinforce the strength of the cable 100-2. For example, the stranded conductors 102 may be comprised of aluminum and the core can be comprised of steel stranded wires such as in an ACSR or ACSS cable or a composite material such as in an ACCR cable, ACFR cable, or ACCC cable. In some embodiments, all conductors are comprised of an Al-CNT composite material, where the CNT is dispersed uniformly through the entirety of each conductor and the core is comprised of steel wires or composite wires.

The number (typically 1, 7, or 19) and gauge of wires stranded together to form the core and number and gauges of the outer stranded conductors may be appropriately modified in accordance with a purpose of use of the cable 100-2. While the cross-sectional shapes of the core wires and outer conductors are shown as round, the cross-sectional shape may also be trapezoidal, for example in an ACSR/TW cable. In some embodiments, an insulating material such as a polymer sleeve (not shown) can cover the outermost surface of the cable.

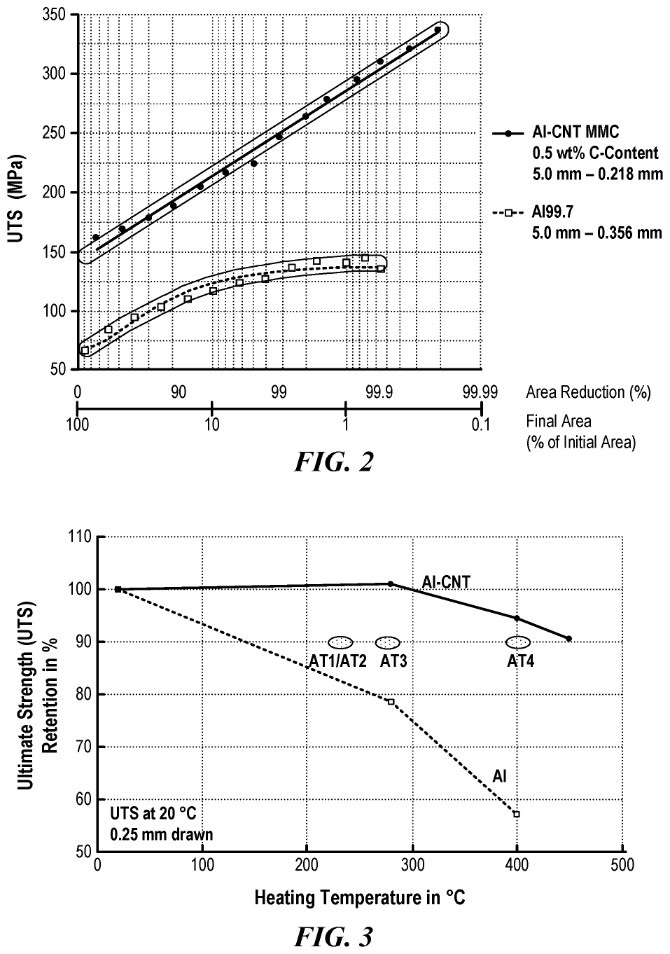

FIG. 2 is a graph that compares the strengthening of a 5 mm diameter extruded Al-CNT rod and a 5 mm diameter extruded aluminum (99.7%) rod upon reduction of wire size by successively applying cold drawing steps. The strengthening in the Al-CNT material is due to work and dispersion hardening, whereas strengthening of Al is due to work hardening alone. The CNT is already dispersed in Al-CNT rod in the as-extruded condition. Thus, the initial strength of 145 MPa before drawing is already greater than the initial Al strength of 75 MPa. While the initial rates of strengthening with successive reduction in wire size by applying cold work are similar for Al-CNT and Al 99.7%, the rate of strengthening with successive reduction in wire size remains constant for Al-CNT while it decreases noticeably for Al 99.7%.

The initial extrusion diameter (Dᵢ) of an Al-CNT rod for a desired ultimate strength (UTS) and final diameter (D_{f}) of a wire can be calculated based on the following mathematical relationship:

$${D}_{i} = {D}_{f} * exp ( \frac{UTS - A}{B} ) \qquad Eq . 1$$

Here, A and B are constants that depend on an amount of CNT. For a matrix consisting of Al 99.7 combined with a 0.5 wt % CNT concentration, A and B are about 145 and about 60, respectively.

FIG. 3 is a graph that shows retention of UTS after heating Al and Al-CNT wires at various temperatures. As shown, the Al-CNT wire passes the AT4 specification of the IEC 62004 standard, while Al does not pass AT1/AT2 specifications of the IEC 62004 standard.

TABLE 1 summarizes the heating temperature and time conditions for the various AT specifications of the IEC62004 standard. After heating under the conditions shown, 90% of the initial UTS needs to be retained to meet a particular AT specification.

TABLE 1
IEC 62004 Table 5:

| Duration | Temperature | | | | |
|---|---|---|---|---|---|
| h | ° C. | AT1 | AT2 | AT3 | AT4 |
| 1 | Temperature | 230 | 230 | 280 | 400 |
| | of heating | | | | |
| | Tolerance in | +5 | +5 | +5 | +10 |
| | temperature | −3 | −3 | −3 | −6 |
| 400 | Temperature | 180 | 180 | 240 | 310 |
| | in heating | | | | |
| | Tolerance of | +10 | +10 | +10 | +10 |
| | temperature | −6 | −6 | −6 | −6 |

The ampacity of a material can be calculated according to the Neher-McGrath equation by taking a cable diameter, resistivity at operating temperature and ambient conditions (e.g., temperature, wind, sun) into account using the following equation:

$$AMP = \sqrt{\frac{QC + QR - QS}{{R}_{TC}}} \qquad Eq . 2$$

Where QC represents loss of heat by convection, QR represents loss of heat by radiation, QS represents heat by sun radiation, RTC represents the resistance at operation temperature. The method is described in the IEEE 738 specification.

TABLE 2 summarizes how various AT standards translate to continuous acceptable operating temperatures for 40 years and 400 hours.

TABLE 2
IEC 62004 Table 1:

| Type | | AT1 | AT2 | AT3 | AT4 |
|---|---|---|---|---|---|
| Density at 20° C. | (g/cm³) | 2.703 | 2.703 | 2.703 | 2.703 |
| Allowable continuous | (° C.) | 150 | 150 | 210 | 230 |
| operating temperature, | | | | | |
| 40 years | | | | | |
| Allowable operating | (° C.) | 180 | 180 | 240 | 310 |
| temperature in 400 hr | | | | | |
| Coefficient of linear | (/° C.) | 23 × | 23 × | 23 × | 23 × |
| expansion | | 10⁻⁶ | 10⁻⁶ | 10⁻⁶ | 10⁻⁶ |
| Constant-mass tempera- | (/° C.) | 0.004 0 | 0.003 6 | 0.004 0 | 0.003 8 |
| ture coefficient of | | | | | |
| resistance at 20° C. | | | | | |

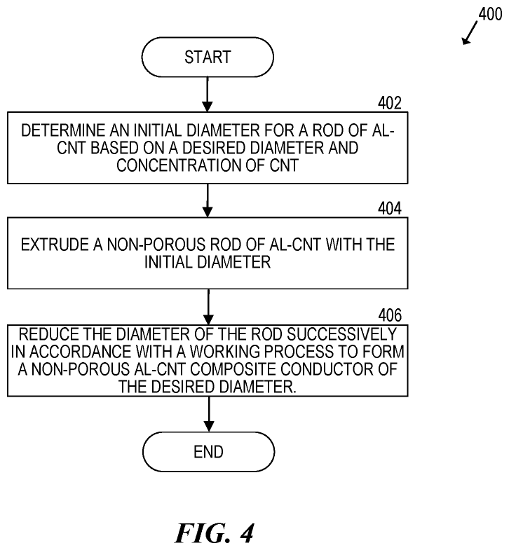

FIG. 4 is a flowchart of an example process for manufacturing an Al-CNT composite wire for a transmission line cable. The process 400 can be performed by a system that includes a computer to control automated operations. For example, the manufacturing process can be controlled by a computer coupled to robotic manufacturing equipment, including an extruder and tooling for performing work hardening and dispersion hardening of the Al-CNT rod, by drawing it down to a wire with a desired diameter as described above.

In 402, an initial diameter for an extruded Al-CNT rod is determined in accordance with Equation 1. The initial diameter must be set relative to the desired final diameter such that the Al-CNT wire can have a desired strength and dispersion of CNT. In particular, the initial diameter is based on a concentration of CNT in the Al-CNT material and the final diameter of the Al-CNT wire. For example, a computer that controls a configurable extruder can set the extruder to continuously extrude an Al-CNT rod having the initial diameter.

In 404, the Al-CNT rod is extruded with the initial diameter set in 402. In particular, the extruder creates the Al-CNT rod with a fixed cross-sectional profile by pushing Al-CNT material through a die that defines the initial diameter. The Al-CNT material input to the extruder may include only Al and CNT, except for the possibility of insignificant amounts of impurities. The extrusion process can operate either in a batch mode to form a discrete Al-CNT billet or rod, or preferably, in a continuous mode to form an Al-CNT rod of any length. The continuous mode is preferable because the Al-CNT material is not limited to a fixed volume such as a billet. In other words, Al-CNT rod can be formed of any length by continuously processing Al-CNT material, rather than needing to form the Al-CNT material in a batch process of billets. The extrusion process provides an Al-CNT material with CNT dispersed throughout the Al matrix. Although small aggregates of CNT may be present, the concentration of CNT throughout the Al matrix is consistent and uniform at a macroscopic level.

In 406, the extruded Al-CNT rod undergoes a working process to reduce the cross-section successively to obtain the Al-CNT wire of the desired final diameter. The working process can improve the even dispersion of CNT throughout an entirety of the Al-CNT composite conductor. In some embodiments, the working process includes a cold working process such as a drawing process.

The resulting Al-CNT wire has a CNT concentration that is uniformly distributed over the entire volume of the Al-CNT wire. That is, there are no significant irregular voids or irregular empty spaces between CNT, the CNT is not aggregated, and there are no areas of higher or lower concentrations of CNT throughout the entire Al-CNT wire. In other words, a CNT amount in an Al matrix is essentially the same in all portions of the matrix volume, i.e., there are no portions within the Al-CNT composite that have a distinct difference, i.e., more than 20%, 10%, or preferably 5% difference, in CNT concentration from any other portion. The resulting Al-CNT composite wire also has a uniform density that is non-porous. For example, the density of the Al-CNT composite may deviate by 2% at most from the theoretical composite density, which can be calculated based on the volume of the material, the relative amounts of Al and CNT, and their respective densities. The uniform CNT concentration of a sample Al-CNT composite wire provides consistent and uniform characteristics such as uniform conductance throughout the entire volume of the Al-CNT wire. The uniform CNT distribution in a sample Al-CNT wire can be verified by high resolution microscopy.

All Aluminum Alloy Cables (AAAC)

In some examples, AAAC cables are used as bare overhead conductors for primary and secondary distribution. Since these types of cables do not have a high strength core, a high strength alloy such as aluminum 6201-T81 (Al—Mg—Si), as specified in ASTM standard B398/B398M, can be used to achieve high strength to weight ratios and desired sag characteristics. 6201-T81 Al has a tensile strength of about 315 to 330 MPa at 3% elongation, but a higher resistivity of 3.28 μΩ-cm (52.5% IACS), compared to 1350-H19 Al, which has a resistivity of 2.82 μΩ-cm (61.2% IACS) and a tensile strength of about 160 to 170 MPa at 2.3 to 1.4% elongation, respectively.

AAAC cables are available in various standard designs with 7, 19, and 37 strands of wires as specified in ASTM standard B399/B399B. The rated strength of a cable will depend on the diameter of the individual wires and the number of strands; however, the individual cable will have a strength between 289 and 319 MPa.

Replacing the individual Al 6201-T81 alloy conductors in an AAAC cable with work and dispersion hardened Al-0.5 wt % CNT conductors of equal tensile strength will result in an increased ampacity according to the lower resistivity and higher heat resistance of Al-0.5 wt % CNT composite conductors compared to Al 6201-T81 alloy conductors. Because the Al-0.5 wt % CNT wires satisfy the AT4 specification of the IEC 62004 standard, AAAC cables with Al-CNT conductors are capable of running significantly hotter at about 200° C. compared to conventional AAAC cables with Al 6201-T81 conductors limited to about 75° C. (under the environmental conditions assumed in the examples described below) resulting in a marked increase in ampacity as long as a thermal sag specification is still met. An additional benefit is that due to the significantly lower creep compared to Al 6201-T81, connections to clams, bolts, or splices are more reliable.

TABLE 3 lists standard AAAC cables comprising Al 6201-T81 alloy conductors along with information related to stranding, individual conductor and cable size, cable strength, DC and AC resistivity, and ampacity rating based on a maximum operating temperature 75° C. Assumed conditions for ampacity are 25° C. ambient temperature, installation of the cable at sea level in a north-south direction at 30 degrees latitude, a wind speed of 2 ft/sec perpendicular to the cable at noon on June 10^{th}, on a clear day, with a cable emissivity of 0.5 and solar absorptivity of 0.5.

TABLE 4 lists Al-CNT cables comprised of Al-0.5 wt % CNT instead of 6201-T81 conductors, where the individual Al-0.5 wt % CNT conductors have the same diameter and strength as the individual Al 6201-T81 alloy conductors in the respective AAAC cable listed in TABLE 3, but with lower electrical DC and AC resistivity due to the increased conductivity of Al-0.5 wt % CNT (60% IACS) compared to 6201-T81 Al (52.5% IACS). Also listed in TABLE 4 are the initial extrusion diameters required for an Al-0.5 wt % CNT rod that is drawn down to the final individual conductor diameter and strength as in the respective individual Al 6201-T81 alloy conductors in the respective AAAC cable listed in TABLE 3 and calculated according to Equation 1. The Al-0.5 wt % CNT cables will generally have a higher ampacity rating compared to the respective AAAC cables due to their IEC 62004 AT4 heat resistance and higher conductivity, and accordingly lower Joule heating allowing for operation temperatures of about 200° C., as discussed in Examples below.

TABLE 3
Properties of AAAC cables with Al 6201-T81 conductors:

| | | Conductor | Conductor | Conductor | Conductor | Cable | Cable |
|---|---|---|---|---|---|---|---|
| AAAC | | Diameter | Diameter | Area | Area | Area | Area |
| Cable | Stranding | (in) | (mm) | (in²) | (mm²) | (in²) | (mm²) |
| Akron | 7 | 0.0661 | 1.6789 | 0.0034 | 0.0000 | 0.0240 | 15.48 |
| Alton | 7 | 0.0834 | 2.1184 | 0.0055 | 0.0000 | 0.0382 | 24.65 |
| Ames | 7 | 0.1052 | 2.6721 | 0.0087 | 0.0001 | 0.0608 | 39.23 |
| Azusa | 7 | 0.1327 | 3.3706 | 0.0138 | 0.0002 | 0.0968 | 62.45 |
| Anaheim | 7 | 0.149 | 3.7846 | 0.0174 | 0.0002 | 0.1221 | 78.77 |
| Amherst | 7 | 0.1672 | 4.2469 | 0.0220 | 0.0004 | 0.1537 | 99.16 |
| Alliance | 7 | 0.1878 | 4.7701 | 0.0277 | 0.0006 | 0.1939 | 125.10 |
| Butte | 19 | 0.1283 | 3.2588 | 0.0129 | 0.0001 | 0.2456 | 158.45 |
| Canton | 19 | 0.1441 | 3.6601 | 0.0163 | 0.0002 | 0.3099 | 199.94 |
| Cairo | 19 | 0.1565 | 3.9751 | 0.0192 | 0.0003 | 0.3655 | 235.81 |
| Darien | 19 | 0.1716 | 4.3586 | 0.0231 | 0.0004 | 0.4394 | 283.48 |
| Elgin | 19 | 0.1853 | 4.7066 | 0.0270 | 0.0006 | 0.5124 | 330.58 |
| Flint | 37 | 0.1415 | 3.5941 | 0.0157 | 0.0002 | 0.5818 | 375.35 |
| Greeley | 37 | 0.1583 | 4.0208 | 0.0197 | 0.0003 | 0.7282 | 469.81 |
| | Rated | Rated | Rated | Rated | | | Allowable |
| AAAC | Strength | Strength | Strength | Strength | R-DC | R-AC | Ampacity |
| Cable | (lbs) | (lbs/in²) | (kg) | (MPa) | @ 20° C. | @ 75° C. | (Amps) |
| Akron | 1110 | 46250 | 503 | 319 | 0.659 | 0.7850 | 107 |
| Alton | 1760 | 46073 | 798 | 318 | 0.414 | 0.4930 | 143 |
| Ames | 2800 | 46053 | 1270 | 318 | 0.260 | 0.3100 | 191 |
| Azusa | 4280 | 44215 | 1941 | 305 | 0.163 | 0.1950 | 256 |
| Anaheim | 5390 | 44144 | 2445 | 304 | 0.130 | 0.1540 | 296 |
| Amherst | 6790 | 44177 | 3080 | 305 | 0.103 | 0.1230 | 342 |
| Alliance | 8560 | 44146 | 3883 | 304 | 0.082 | 0.0973 | 395 |
| Butte | 10500 | 42752 | 4763 | 295 | 0.064 | 0.0769 | 460 |
| Canton | 13300 | 42917 | 6033 | 296 | 0.051 | 0.0610 | 532 |
| Cairo | 15600 | 42681 | 7076 | 294 | 0.043 | 0.0518 | 590 |
| Darien | 18800 | 42786 | 8528 | 295 | 0.036 | 0.0431 | 663 |
| Elgin | 21900 | 42740 | 9934 | 295 | 0.031 | 0.0360 | 729 |
| Flint | 24400 | 41939 | 11068 | 289 | 0.027 | 0.0309 | 790 |
| Greeley | 30500 | 41884 | 13835 | 289 | 0.022 | 0.0272 | 908 |

TABLE 4
Properties of AAAC-like cables with Al-0.5 wt % CNT conductors:

| Equivalent | | Conductor | Conductor | Conductor | Conductor | Cable | Cable | Rated |
|---|---|---|---|---|---|---|---|---|
| AAAC | | Diameter | Diameter | Area | Area | Area | Area | Strength |
| Cable | Stranding | (in) | (mm) | (in²) | (mm²) | (in²) | (mm²) | (lbs) |
| Akron | 7 | 0.0661 | 1.6789 | 0.0034 | 0.0000 | 0.0240 | 15.48 | 1110 |
| Alton | 7 | 0.0834 | 2.1184 | 0.0055 | 0.0000 | 0.0382 | 24.65 | 1760 |
| Ames | 7 | 0.1052 | 2.6721 | 0.0087 | 0.0001 | 0.0608 | 39.23 | 2800 |
| Azusa | 7 | 0.1327 | 3.3706 | 0.0138 | 0.0002 | 0.0968 | 62.45 | 4280 |
| Anaheim | 7 | 0.149 | 3.7846 | 0.0174 | 0.0002 | 0.1221 | 78.77 | 5390 |
| Amherst | 7 | 0.1672 | 4.2469 | 0.0220 | 0.0004 | 0.1537 | 99.16 | 6790 |
| Alliance | 7 | 0.1878 | 4.7701 | 0.0277 | 0.0006 | 0.1939 | 125.10 | 8560 |
| Butte | 19 | 0.1283 | 3.2588 | 0.0129 | 0.0001 | 0.2456 | 158.45 | 10500 |
| Canton | 19 | 0.1441 | 3.6601 | 0.0163 | 0.0002 | 0.3099 | 199.94 | 13300 |
| Cairo | 19 | 0.1565 | 3.9751 | 0.0192 | 0.0003 | 0.3655 | 235.81 | 15600 |
| Darien | 19 | 0.1716 | 4.3586 | 0.0231 | 0.0004 | 0.4394 | 283.48 | 18800 |
| Elgin | 19 | 0.1853 | 4.7066 | 0.0270 | 0.0006 | 0.5124 | 330.58 | 21900 |
| Flint | 37 | 0.1415 | 3.5941 | 0.0157 | 0.0002 | 0.5818 | 375.35 | 24400 |
| Greeley | 37 | 0.1583 | 4.0208 | 0.0197 | 0.0003 | 0.7282 | 469.81 | 30500 |
| Equivalent | Rated | Rated | Rated | | | Allowable | Extrusion | Extrusion |
| AAAC | Strength | Strength | Strength | R-DC | R-AC | Ampacity | Diameter | Diameter |
| Cable | (lbs/in²) | (kg) | (MPa) | @ 20° C. | @ 75° C. | (Amps) | (in) | (mm) |
| Akron | 46250 | 503 | 319 | 0.577 | 0.6869 | 195 | 1.2011 | 30.51 |
| Alton | 46073 | 798 | 318 | 0.362 | 0.4314 | 263 | 1.4850 | 37.72 |
| Ames | 46053 | 1270 | 318 | 0.228 | 0.2713 | 355 | 1.8688 | 47.47 |
| Azusa | 44215 | 1941 | 305 | 0.143 | 0.1706 | 480 | 1.9084 | 48.47 |
| Anaheim | 44144 | 2445 | 304 | 0.114 | 0.1348 | 557 | 2.1254 | 53.99 |
| Amherst | 44177 | 3080 | 305 | 0.090 | 0.1076 | 648 | 2.3941 | 60.81 |
| Alliance | 44146 | 3883 | 304 | 0.072 | 0.0851 | 753 | 2.6796 | 68.06 |
| Butte | 42752 | 4763 | 295 | 0.056 | 0.0673 | 883 | 1.5596 | 39.61 |
| Canton | 42917 | 6033 | 296 | 0.045 | 0.0534 | 1027 | 1.7851 | 45.34 |
| Cairo | 42681 | 7076 | 294 | 0.038 | 0.0453 | 1145 | 1.8869 | 47.93 |
| Darien | 42786 | 8528 | 295 | 0.032 | 0.0377 | 1289 | 2.0939 | 53.18 |
| Elgin | 42740 | 9934 | 295 | 0.027 | 0.0315 | 1427 | 2.2493 | 57.13 |
| Flint | 41939 | 11068 | 289 | 0.024 | 0.0270 | 1554 | 1.5665 | 39.79 |
| Greeley | 41884 | 13835 | 289 | 0.019 | 0.0238 | 1796 | 1.7415 | 44.23 |

Aluminum Conductor Steel Reinforced Cables (ACSR)

ACSR cables are used as bare overhead transmission conductors and as primary and secondary distribution conductors and messenger support. ACSR cables include a steel core, as described in ASTM standard B500/B500M, and outer aluminum conductors, typically aluminum 1350-H19, as described in ASTM standard B230/B230M. The strength of ACSR cables is supplied by both the aluminum conductors and steel core and is calculated according to ASTM standard B498/B498M by taking the strength of aluminum conductors and steel core at 1% elongation into account.

Steel has a higher strength than aluminum and, as such, the steel reinforcement in ACSR allows for increased mechanical tension on the cable. Steel also exhibits less creep than aluminum and a lower coefficient of thermal expansion. Thus, the steel reinforcement in ACSR cables supplies mechanical support for the aluminum conductor against sagging and, as such, facilitates installation of long spans of cable.

By varying the relative cross-sectional areas of steel and aluminum strands, a cable can be made stronger at the expense of its electrical conductivity. Steel has a conductivity of about 8% IACS and a density of about 7.8 g/cm³ compared to 1350-H19 aluminum, which has a conductivity of about 61.2% IACS and a density of about 2.71 g/cm³. Therefore, the steel reinforcement results in a decreased conductivity and increased weight compared to an AAAC cable of a similar cross-section. However, the lower electrical conductivity only has a small effect on the current carrying capability or ampacity rating at operating frequency, because current is carried in the aluminum conductors due to the skin effectively pushing current to the surface of a conductor. The normal operating temperature of ACSR cables is limited to less than 100° C., and about 135° C. to 150° C. for short-term emergency operations. This is to avoid aluminum conductor annealing that results in softening and a permanent loss in strength of the aluminum conductor.

Al-0.5 wt % CNT conductors exhibit an electrical conductivity of about 60% IACS, which is only slightly less than 1350-H19 Al wires with a conductivity of about 61.2% IACS. By replacing 1350-H19 Al alloy conductors with Al-CNT in ACSR transmission line cables, a higher ampacity can be achieved.

Because work and dispersion hardened Al-0.5 wt % CNT conductors exceed the AT4 specification of the IEC 62004 heat resistance standard, a higher cable strength can be achieved by replacing the 1350-H19 Al conductors with Al-CNT conductors in an ACSR cable.

Since Al-0.5 wt % CNT conductors exhibit a similar conductivity, a higher tensile strength, a higher creep resistance, and a higher heat resistance compared to Al 1350-H19 conductors with similar cross-sections, it is therefore beneficial to replace 1350-H19 Al conductors in ACSR cables with Al-CNT 0.5% conductors of similar cross-sectional dimension.

This increases the possible operating temperature of the ACSR cable from 75° C. to more than 200° C. during normal operation at the environmental condition used in examples described below, thereby resulting in a substantial increase in the cable ampacity rating. Because the Al-0.5 wt % CNT conductors exhibit a higher strength and higher creep resistance than the 1350-H19 Al conductors, they will contribute to the overall mechanical strength in an ACSR cable.

For example, in a Drake cable with 7 strands of class A steel with a 0.1360 inch diameter and 180 ksi stress at 1% elongation and 26 strands of aluminum 1350-H19 with 0.1749 inch diameter and a 26 ksi stress at 1% elongation, the strength is calculated as:

$$( 26 * \frac{π}{4} {( 0.1749 )}^{2} * 24 * 0.93 + 7 * \frac{π}{4} {( 0.1360 )}^{2} * 180 * 0.96 ) lbs = 31515 lbs \qquad Eq .3$$

Where the stress values for aluminum and steel and the derating factors of 93% and 96% are reproduced from Table 1 of ASTM standard B230/B230M, Table 2 of ASTM standard B498/B498M, and Table 6 of ASTM standard B232/B232M. Obviously, if the strength of the aluminum strands in an ACSR cable is increased, the strength of the cable is increased. This will allow for the cable to be installed at higher tension, which will result in inversely proportional lower sag.

The 200° C. operating temperature is similar to the operating temperature of ACSS cables; however, ACSS cables comprise annealed and dead-soft Al 1350-0 conductors providing almost no strength to ACSS cables, which rely entirely on the steel core for strength. Thus, ACSR cables with Al-CNT conductors combine the benefits of ACSR and ACSS cables with high strength and high ampacity through high conductivity, heat resistance, and tensile strength of Al-CNT.

The maximum operating temperature for ACSR cables with Al-CNT strands would, however, still be limited to around 245° C. to 250° C., where the galvanized coatings used on the steel core could deteriorate rapidly.

Specialty ACSR cables with heat resistant Al-alloys such as Al—Zr are available for operation at higher temperatures. These types of cables, however, have a lower conductivity than 1350-H19 aluminum. The Al-CNT composite, in comparison, provides the strength and heat resistance of Al—Zr while exhibiting about the same conductivity as 1350-H19 aluminum. An additional benefit is that due to the significantly lower creep compared to Al 1350-H19, connections to clamps, bolts, or splices are more reliable.

Aluminum Conductor Steel Supported Cables (ACSS)

ACSS cables are used in overhead distribution and transmission lines. ACSS cables visually appear similar to ACSR cables; the steel core in ACSS supplies support for the aluminum wires against sagging. A difference is that the aluminum strands in ACSS are fully annealed Aluminum 1350-O as described in ASTM standard B609/B609M. They are “dead-soft” and therefore do not provide much strength to the cable. After installation, permanent elongation of the aluminum strands results in a much larger percentage of the conductor tension being carried in the steel core compared to standard ACSR. This in turn yields reduced composite thermal elongation and increases self-damping. For that reason, ACSS cables sag less than ACSR cables. Since the aluminum strands are “dead-soft,” ACSS cables can be continuously operated at temperatures in excess of 200° C. without loss of strength. A maximum operating temperature is limited to around 245° C. to 250° C., where the galvanized coatings used on the steel core could deteriorate rapidly. Again, steel has a conductivity of only 8% IACS and a density of 7.8 g/cm³ compared to 1350-O aluminum with a conductivity of 61.8% IACS and density of 2.71 g/cm³. Therefore, the support results in an increased loss of conductivity and increased weight compared to an AAAC cable of similar cross-section.

Because ACSS cables are designed to operate at temperatures in excess of 200° C., replacing fully annealed Al conductors with Al-CNT conductors may not yield any improvement in ampacity. However, the increased strength and high creep resistance of Al-CNT compared to Al 1350-O will contribute to an overall higher cable strength and make connections with clamps, bolts, or splices are more reliable.

Thus, the disclosed embodiments show that replacing Al conductors and strands with Al-CNT conductors and strands around a steel core combines the benefits of ACSR and ACSS of high strength, high conductivity, and high ampacity.

Composite Core Aluminum Cables

Aluminum conductor fiber reinforced (ACFR) cables with a carbon-fiber core, aluminum conductor composite reinforced (ACCR) cables with an aluminum-matrix composite core, and aluminum conductor composite core (ACCC) cables are examples of a later type of transmission line cable. The composite cores have a high strength to weight ratio and a lower expansion coefficient compared to steel, providing low sag at elevated temperatures. ACFR can withstand up to 150° C., and ACCR up to 230° C. These emerging designs are often used with high heat resistance Al-alloys such as Al—Zr, which for a high conductivity only satisfies the AT3 standard. It will be beneficial to replace these Al-alloy conductors with Al-CNT, which satisfies the AT4 standard.

The disclosed embodiments include a solution to the aforementioned problems. The following ampacity calculations for AAAC and ACSR cables, were performed using ETAP, which calculates ampacity based on the IEEE 738 Standard. Replacing Al 6201 alloy conductors with Al-CNT conductors in AAAC cables or Al 1350-H19 conductors with Al-CNT conductors in ACSR cables results in higher ampacity ratings as the operating temperature can be increased from 75° C. to 200° C. Replacing Al or Al-alloy conductors with Al-CNT conductors in ACSS, ACFR, ACCR, or ACCC cables will generally result in similar benefits, which, however, will depend on the design of the cable.

### Example Embodiment: AAAC-Like Cables with Al-0.5 wt % CNT Conductors

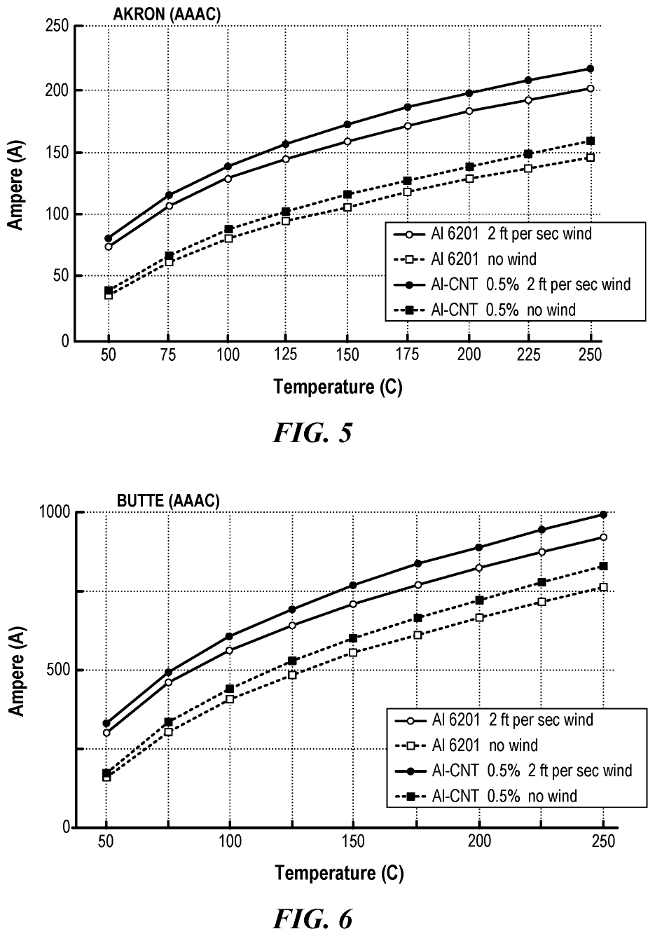

FIG. 5 is a graph that shows the ampacity at given line temperatures for a transmission line installed in a north to south direction at 30 degrees latitude at sea level for an Akron AAAC cable with an emissivity of 0.5 and a solar absorptivity of 0.5. In this example, environmental conditions include 25° C. ambient temperature, a wind speed of 0 and 2 ft/sec perpendicular to the transmission line at noon on June 10, on a clear day. The wind perpendicular to the line is cooling down the line, which results in a higher allowed ampacity. The ampacity for an AAAC Akron cable at a wind speed of 2 ft/sec is 107 Amps for a temperature not to exceed 75° C., which is consistent with published specification sheets.

Replacing the Al 6201-T81 conductors with Al-CNT conductors in the cable allows temperatures in excess of 200° C. as the higher temperature will not result in any loss of strength of the Al-CNT conductors. The ampacity at 2 ft/sec wind speed will increase to 195 Amps. Notably, the ampacity curves for Al-CNT 0.5 wt % are above the ampacity curves for Al 6201-T81 alloy due to the about 8% higher conductivity of Al-0.5 wt % CNT compared to Al 6201-T81 alloy. The individual conductors of an Akron cable are 0.0661 inch (1.68 mm) in diameter. To obtain the rated strength of 319 MPa with Al-CNT, according to Equation 1, extrusions are started at an initial diameter of 1.2011 inches (30.51 mm).

FIG. 6 is a graph that shows the ampacity at given line temperatures for a transmission line installed in a north-to-south direction at 30 degrees latitude, at sea level for a Butte AAAC cable with an emissivity of 0.5 and a solar absorptivity of 0.5. In this example, environmental conditions include 25° C. ambient temperature, a wind speed of 0 and 2 ft/sec perpendicular to the transmission line at noon on June 10, on a clear day. The wind perpendicular to the line cools down the line resulting in a higher allowed ampacity. The ampacity for an AAAC Butte cable at a wind speed of 2 ft/sec is 460 Amps for a temperature not to exceed 75° C., which is consistent with published specification sheets.

Replacing the Al 6201-T81 conductors with Al-CNT conductors in the cable allows temperatures in excess of 200° C. as the higher temperature will not result in any loss of strength of the Al-CNT conductors. The ampacity at 2 ft/sec wind speed will increase to 883 Amps. Notably, the ampacity curves for Al-0.5 wt % CNT are above the ampacity curves for Al 6201-T81 alloy due to the about 8% higher conductivity of Al-0.5 wt % CNT compared to Al 6201-T81 alloy. The individual conductors of a Butte cable are 0.1283 inch (3.26 mm) in diameter. To obtain the rated strength of 295 MPa with Al-CNT, according to Equation 1, extrusions are started at an initial diameter of 1.5596 inches (39.61 mm).

ACSR-Like Cables with Al-0.5 wt % CNT Conductors

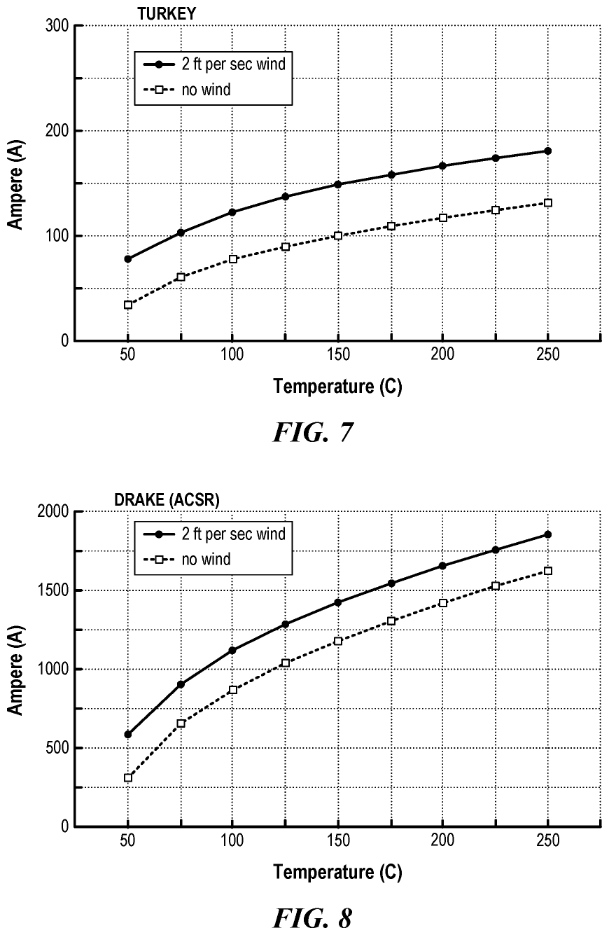

FIG. 7 is a graph showing the ampacity at given line temperatures for a transmission line installed in a north-to-south direction at sea level and 30 degrees latitude, for a Turkey ACSR cable with an emissivity of 0.5 and a solar absorptivity of 0.5. In this example, environmental conditions include 25° C. ambient temperature, wind speed of 0 and 2 ft/sec perpendicular to the transmission line at noon on June 10, on a clear day. The wind perpendicular to the line is cooling down the line resulting in a higher allowed ampacity. The ampacity for an ACSR Turkey cable at a wind speed of 2 ft/sec is 103 Amps for a temperature not to exceed 75° C., which is consistent with published specification sheets.

Replacing the Al 1350-H19 conductors with Al-CNT conductors in the cable allows for temperatures in excess of 200° C. as the higher temperature will not result in any loss of strength of the Al-CNT conductors. The ampacity at 2 ft/sec wind speed will increase to 166 Amps. The strength of ACSR cables is provided by the steel core and the Al conductors. Replacing the Al 1350-H19 conductors with high strength Al-CNT conductors will improve the overall strength of the cable according to Equation 3. The individual Al conductors of a Turkey cable have a diameter of 0.0661 inch (1.68 mm) and are rated at 28.5 ksi (196.5 MPa) at 1% elongation. If they are replaced by Al-0.5 wt % CNT conductors with a strength of 35 ksi (241.3 MPa) at 1% elongation, the cable strength increases from 1190 lbs to 1317 lbs or about 10.6%. Increasing the cable tension accordingly will reduce sag by about 10%. To obtain the rated strength of 241.3 MPa with Al-CNT, according to Equation 1, extrusions are started at an initial diameter of 0.3290 inches (8.36 mm).

FIG. 8 is a graph showing the ampacity at given line temperatures for a transmission line installed in a north-to-south direction at sea level and 30 degrees latitude, for a Drake ACSR cable with an emissivity of 0.5 and a solar absorptivity of 0.5. In this example, environmental conditions include 25° C. ambient temperature, wind speed of 0 and 2 ft/sec perpendicular to the transmission line at noon on June 10. The wind perpendicular to the line is cooling down the line resulting in a higher allowed ampacity. The ampacity for an ACSR Drake cable at a wind speed of 2 ft/sec is 908 Amps for a temperature not to exceed 75° C., which is consistent with published specification sheets.

Replacing the Al 1350-H19 conductors with Al-CNT conductors in the cable allows for temperatures in excess of 200° C. as the higher temperature will not result in any loss of strength of the Al-CNT conductors. The ampacity at 2 ft/sec wind speed will increase to 1651 Amps. The strength of ACSR cables is provided by the steel core and the Al conductors. Replacing the Al 1350-H19 conductors with high strength Al-CNT conductors will improve the overall strength of the cable according to Equation 3. The individual Al conductors of Drake have a diameter of 0.1749 inch (4.44 mm) and are rated at 24 ksi (165.5 MPa) at 1% elongation. If they are replaced by Al-0.5 wt % CNT conductors with a strength of 35 ksi (241.3 MPa) at 1% elongation, the cable strength is increased from 31,500 lbs to 37,900 lbs or about 20.3%. Increasing the cable tension accordingly will reduce sag by about 17%. To obtain the rated strength of 241.3 MPa with Al-CNT, according to Equation 1, extrusions are started at an initial diameter of 0.8706 inches (22.11 mm).

Reference in this specification to “one embodiment” or “an example” means that a particular feature, structure, or characteristic described in connection with the embodiment is included in at least one embodiment of the disclosure. The appearances of the phrase “in one embodiment” in various places in the specification are not all necessarily referring to the same embodiment, nor are separate or alternative embodiments mutually exclusive of other embodiments. Moreover, various features are described, which may be exhibited by some embodiments and not by others. Similarly, various requirements are described, which may be requirements for some embodiments but not for other embodiments.

The disclosure includes various non-limiting examples that refer to specific materials or other details that are well known to persons skilled in the art and, as such, are omitted herein for the sake of brevity. Additional details are readily available online or elsewhere. For example, details regarding aluminum materials referenced in the disclosed examples can be found as follows.

From the foregoing, it will be appreciated that specific embodiments of the invention have been described herein for purposes of illustration, but that various modifications may be made without deviating from the scope of the invention. Accordingly, the invention is not limited except as by the appended claims.

1. A transmission or distribution line cable comprising:
a plurality of conductors comprising:
a metal-matrix composite (MMC) conductor comprising:
a plurality of carbon nanotubes (CNT) that are evenly dispersed in an aluminum (Al) metal matrix,
wherein the concentration of CNT is uniform throughout an entirety of the MMC conductor.

2. The transmission or distribution line cable of claim 1, wherein the plurality of conductors are stranded, with each strand comprising:
an MMC comprising CNT and Al,
wherein the concentration of CNT is uniform throughout an entirety of each MMC strand.

3. The transmission or distribution line cable of claim 2, further comprising:
a plurality of stranded core wires surrounded by a plurality of MMC conductors stranded around the stranded core wires,
wherein any of the plurality of stranded core wires has a greater tensile strength and a lower conductivity compared to any of the plurality of stranded MMC conductors.

4. The transmission or distribution line cable of claim 1, further comprising:
a plurality of core wires,
wherein any of the plurality of core wires have a greater tensile strength compared to any of the plurality of conductors other than the plurality of core wires.

5. The transmission or distribution line cable of claim 2, wherein the MMC conductors comprise CNT in a range of 0.1 weight percent (wt %) to 2 wt %.

6. The transmission or distribution line cable of claim 5, wherein the MMC conductors comprise CNT in a range of 0.4 wt % to 0.6 wt %.

7. The transmission or distribution line cable of claim 6, wherein the MMC conductors comprise about 0.5 wt % CNT.

8. The transmission or distribution line cable of claim 4, wherein each core wire comprises steel.

9. The transmission or distribution line cable of claim 4, wherein each core wire comprises a composite material including a carbon-glass-fiber composite or an aluminum matrix composite.

10. The transmission or distribution line cable of claim 2, wherein the MMC conductors have a conductivity of at least 55% International Annealed Copper Standard (IACS).

11. The transmission or distribution line cable of claim 10, wherein the MMC conductors have a conductivity of about 58% IACS.

12. A transmission or distribution line cable comprising:
a plurality of wires forming a stranded core; and
a plurality of conductors stranded around the stranded core,
wherein the plurality of conductors comprises a metal-matrix composite (MMC) of aluminum (Al) and carbon nanotubes (CNT) having a non-porous structure with CNT dispersed uniformly throughout the MMC.

13. The transmission or distribution line cable of claim 12, wherein the MMC comprises CNT in a range of 0.1 weight percent (wt %) to 2 wt %.

14. The transmission or distribution line cable of claim 12, wherein the MMC comprises CNT in a range of 0.25 wt % to 1 wt %.

15. The transmission or distribution line cable of claim 12, wherein the MMC comprises at least 0.4 wt % CNT.

16. The transmission or distribution line cable of claim 12, wherein the MMC comprises CNT in a range of 0.4 wt % to 0.6 wt %.

17. The transmission or distribution line cable of claim 12, wherein the MMC comprises about 0.5 wt % CNT.

18. A method of manufacturing an aluminum carbon nanotube (Al-CNT) composite wire for a transmission or distribution line cable, the method comprising:
extruding a non-porous rod of Al-CNT with an initial diameter; and
reducing the cross-sectional area of the rod successively by a working process to form a non-porous Al-CNT composite conductor of a final diameter less than the initial diameter.

19. The method of claim 18, further comprising, prior to extruding the non-porous rod of Al-CNT:
determining the initial diameter based on the final conductor diameter, conductor ultimate tensile strength, and an amount of CNT in Al-CNT input to an extruder that extrudes the non-porous rod of Al-CNT.

20. The method of claim 18, wherein the working process improves the even dispersion of CNT throughout an entirety of the Al-CNT composite conductor.

21. The method of claim 18, wherein the working process includes a cold working process.

22. The method of claim 18, wherein the working process includes at least one of a rolling process or a drawing process.
